(19) United States
(12) Patent Application Publication
(10) Pub. No.: US 2009/0323558 A1
(43) Pub. Date: Dec. 31, 2009

(54) System and an improved method for controlling multimedia features and services in a sip-based phones

(76) Inventor: Venkat Stinivas Meenavalli, Andhra Pradesh (IN)

Correspondence Address: KANESAKA BERNER AND PARTNERS LLP, 1700 DIAGONAL RD, SUITE 310, ALEXANDRIA, VA, 22314-2848, US

(21) Appl. No.: 11/919,971

(22) PCT Filed: May 10, 2005
(86) PCT No.: PCT/IN2005/000151

§ 371 Date: Apr. 18, 2008

(51) Int. Cl. H04L 12/16

(52) U.S. Cl. 370/259; 370/352

(57) ABSTRACT

A system for controlling multimedia features and supplementary services in SIP based phones comprising: At least one UAC, operable to request desired data using a RDT message as an expanded SIP and check whether the data is correctly received; at least one UAS, operable to combine the requested data with information indicating whether the data is correctly transmitted, using the RDT message as the expanded SIP, and transmit the resultant data; a SIP terminal which supports two way communication with another SIP entity in real-time and also supports both signaling and media; at least a Proxy server capable of contacting at least one client or the next hop server and passes the call request further; and At least a Redirect Server capable of accepting SIP requests; and At least a Location Server capable of providing information about a caller's possible locations and redirect to the proxy servers.

### FIELD OF INVENTION

The present application relates to system architecture and an improved method for controlling multimedia features and supplementary services in SIP based phones. In particular, the present application relates to an architecture and method for controlling the multimedia features and supplementary services, such as click to call, MP3 Player, Online Advertisements, International Roaming, caller identification (ID) etc that are implemented within Internet Protocol (IP)-based telephony technology using Session Initiation Protocol (SIP) for its communications.

### BACKGROUND OF THE INVENTION

Technological advancements and customer demands have compelled telephone companies and Internet service providers to provide communication “solutions” rather than just a dial tone. The changes in the telecommunications field over the years have encouraged the inventors and others service providers to push carriers far beyond their original core business of providing basic connectivity.

But carriers are faced with a problem. Today's legacy public switched telephone network (PSTN), while reliable and robust, is built on hardware-based circuit switches that leave little room for innovation and service differentiation. Many carriers are solving this problem by migrating networks to IP-based technology, but they may still have huge investments in the PSTN hardware that are not fully depreciated. This means that as network migration continues, a hybrid PSTN/IP environment will emerge, with traffic being directed across both the PSTN and IP systems.

When IP-based telephony technology, such as SIP, emerges, many end devices may be able to provide the multimedia features and supplementary services without permission from the network-centric devices of the service providers. As a result, the capability of controlling the feature/service delivery from these network-centric devices may also be deteriorated. Under this scenario, service providers will likely be able to only enable uniform multimedia features and supplementary services for all of its customer's end devices or rely on static provisioning for each such end device to enable/disable certain unwanted features/services.

Accordingly, service providers want a mechanism of better controlling the multimedia features and supplementary services delivery from the network core, even though these multimedia features and supplementary services are actually provided by the end devices that reside in the end user premises. The present invention defines an architecture and mechanism for network core devices (e.g., SIP servers) to control end devices (e.g., SIP phones) to deliver the multimedia features and supplementary services dynamically and based on per user account profiles. With the architecture and mechanism of the present invention, service providers can selectively provide these services to proper groups of users by indicating such feature/service information in the communication packets (e.g., SIP messages). The end devices used with the present invention will also provide multimedia features and supplementary services only as directed in such communication packets. Consequently, service providers will regain network-concentric control over the multimedia features and supplementary services that they provide in an IP or hybrid PSTN/IP telephony system.

### SUMMARY OF THE INVENTION

The present invention provides a system and method for communicating data using Session Initiation Protocol (SIP) as a communication protocol constructing a New Generation Network (NGN), in order to ensure stable and reliable data transmission.

According to an aspect of the present invention, there is provided a method for communicating data between a client and a server, the method comprising: (a) initializing a communication session using Session Initiation Protocol (SIP); (b) requesting the server for data using a Reliable Data Transfer (RDT) message as an expanded SIP, receiving data, and checking whether the data is correctly received; and (c) terminating the communication session using SIP.

According to another aspect of the present invention, there is provided a computer readable medium comprising: a Session Initiation Protocol (SIP) message, which includes an SIP header part required for initializing a session and an SIP body part capable of performing a desired function through a set session; and an RDT message, which includes a command representing a type of a command to be executed and at least one parameter with information required for executing the command, and is included in the SIP body part.

In another aspect of the present invention, there is provided a system for communicating data between a client and a server, the system comprising: a user agent client (UAC), which requests desired data using a Reliable Data Transfer (RDT) message as an expanded Session Initiation Protocol (SIP) and checks whether the data is correctly received; and a user agent server (UAS), which combines the requested data with information indicating whether the data is correctly transmitted, using the RDT message as the expanded SIP, and transmits the resultant data.

The user agent client (UAC) which requests a server for data comprises: a Reliable Data Transfer (RDT) message processor which converts information on requested data into an RDT message and extracts the requested data from a received RDT message; a Session Initiation Protocol (SIP) stack which communicates an SIP message including an RDT message from/to the server, a data application unit which processes or stores the extracted data; and a data controller, which sends information on requested data to the RDT message processor and transfers a transformed RDT message to the SIP stack, and sends an RDT message received from the SIP stack to the RDT message processor and transfers information on the extracted data to the data application unit.

The user agent server (UAS) which provides data to a client, the server comprising: a Reliable Data Transfer (RDT) message processor which extracts information on requested data from a received RDT message, and transforms the information on requested data into an RDT message; a Session Initiation Protocol (SIP) stack which communicates an SIP message including an RDT message from/to the client; a data provider which provides data corresponding to the information on requested data to a data controller, and a data controller, which sends an RDT message received form the SIP stack to the RDT message processor and transfers information for the extracted data to the RDT message processor, and sends information on data received from the data provider to the data provider and transfers a transformed RDT message to the SIP stack.

According to another aspect of the present invention, there is provided a computer readable medium having embodied thereon a computer program for the data communication method.

The present application provides a method for controlling features and services comprising the step of identifying a profile, specifying which features and services may or may not be implemented by an end device, from user account information stored on a network core device. Moreover, the present application provides another method for controlling features and services in packet-based networks that comprises the steps of sending a first message to a network core device, and identifying a profile, specifying which features and services may or may not be implemented by an end device, from user account information stored on the network core device. The method further comprises the steps of adding the profile to a second message, and sending the second message from the network core device to the end device.

The present application provides a method for controlling features and services like SIP complaint [RFC-3261]. Some of the other features which make the present invention distinguishable from the prior art are:—

Call forwarding: A customer may cause incoming calls to be automatically forwarded to another number for a period of time. The customer may specify one or more numbers on which he is available when the first number does not answer or is busy.

Call blocking or Ignoring calls: The customer may specify one or more numbers from which he or she does not want to receive calls. A blocked caller will bear a rejection message, while the callee will not receive any indication of the call.

Call return: Returns a call to the most recent caller. If the most recent caller is busy, the returned call may be queued until it can be completed.

Call trace: Allows a customer to trigger a trace of the number of the most recent caller.

Last Call Duration: —The caller may trace the last call duration and store it for his information.

Recent Number List: —The caller may have or record a recent called and received number list for his information. The number of the records can be set by the caller.

Caller ID: The caller's number is automatically displayed during the silence period after the first ring. This feature requires the customer's line to be equipped with a device to read and display the out-of-band signal containing the number.

Compatibility: —The present invention is compatible with windows 2000/XP operating systems.

Proxy Authorization support: —If a client wishes to use proxies that require caller authentication, it present invention is able/compatible to recognize the status code, and further able to generate the Proxy Authorization request header and understand the Proxy-Authenticate response header.

Address Book: —Allows a caller to maintain an address book and can be recalled whenever required.

Volume Visualization: —Allows the caller to visualize the volume level present. The volume can be controlled even in the time of the call.

Easy User Installation: —The present invention is made easy to install in the system. The detailed step wise process is given later in the specification.

Click to call: —The present invention is integrated with the IE Browser so that user can watch online advertisements displayed on the browser. User can make a call by clicking on the number displayed in the advertisement. A Tiny server is running behind the application which dials this number automatically.

Music player: —Music player is embedded and the supported Format is: MP3. This MP3 plug-in application is being developed using java. There is a juke box and one can play the songs stored on the system.

Business Processing; The present invention allows companies to advertise though the system. Their company strips were displayed on the Dialer. So customers can go even for online shopping through the present invention.

Real-time online adding of funds: —Customers can add funds in to their accounts while online through their credit cards.

Caller ID blocking: Allows a caller to block the display of their number in a callee's caller ID device.

Priority ringing: Allows a customer to specify a list of numbers for which, when the customer is called by one of the numbers, the customer will hear a distinctive ring.

Conference calling: Two or more parties can be connected to one another by dialing into a conference bridge number.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE ACCOMPANYING DRAWINGS

The above and other features and advantages of the present invention will become more apparent by describing in detail exemplary embodiments thereof with reference to the attached drawings in which:

FIGS. 1A and 1B are views for explaining a system that communicates data between a user agent client (UAC) and a user agent server (UAS), according to the present invention;

FIG. 2 is a flowchart illustrating a process for communicating data between a client and a server, according to the present invention.

FIG. 3 is a flow diagram illustrating control via a register message of features and services used by an end device.

FIG. 4A shows the Player Architecture as per the present invention.

FIG. 4B is a communication diagram representing the process of communicating random data in SIP-PSTN call flow.

FIG. 4C is a communication diagram representing the process of communicating random data in SIP-SIP call flow.

FIG. 5 shows Globe7 Video Telephone Music (VTM) Player signaling Code Flow.

FIG. 6 shows Globe7 Video Telephone Music (VTM) Player Real time Protocol (RTP) Communication Code Flow.

FIG. 7 shows the GUI (Graphical User Interface) of the Globe7 Video Telephone as per the present invention.

FIG. 8 shows the GUI (Graphical User Interface) of the authentication/Registration method.

FIG. 9A shows the GUI (Graphical User Interface) of the dial pattern.

FIG. 9B is a Comparison chart with other available SIP based phones

FIG. 10 describes the basic Music Code Flow Diagram.

FIG. 11 shows the GUI (Graphical User Interface) of the music player.

### DETAILED DESCRIPTION OF EXEMPLARY EMBODIMENTS

SIP, the Session Initiation Protocol, is a signaling protocol for Internet conferencing, telephony, presence, events notification and instant messaging. SIP was developed within the IETF MMUSIC (Multiparty Multimedia Session Control) working group. SIP is a text-based protocol, similar to MTP and SMTP, for initiating interactive communication sessions between users. Such sessions include voice, video, chat, interactive games, and virtual reality.

SIP, Session Initiation Protocol, is a signaling protocol over IP mainly deployed for Internet conferencing, telephony, presence, events notification and instant messaging.

Request/response protocol (like HTTP but peer-peer)

Simple and extensible.

Designed for mobility (proxy redirect servers)

Bi-directional authentication

Capability negotiation.

SIP is used for controlling the signaling that enables manipulation of sessions such as:
1. Instant messaging sessions
2. Phone calls over the Internet
3. Gaming Servers.
4. Resource Location

### Architecture

This present invention is using Java Integrated Network (JAIN) SIP stack. Here the coding is done using java. Further there is a UAC (User Agent Client) and UAS (User Agent Saver) running in the code. The UAC of the caller communicates with the UAS of the callee. This is done with a proxy in the middle. The proxy server contacts one or more clients or next hops to servers and passes the call requests further servers having UAC and UAS.

JMF: Java Media Framework. is set of libraries for building multimedia applications in java. It provides RTP/RTCP interfaces to send and receive real time multimedia, interfaces for audio and video playback. Once a sip session is established, RTP libraries were used to send the real time audio and video data.

Session Initiation Protocol (SIP) is the Internet Engineering Task Force's standard for multimedia conferencing over IP. SIP is an ASCII-based, application-layer control protocol that can be used to establish, maintain, and terminate calls between two or more end points. Like other VoIP protocols, SIP is designed to address the functions of signaling and session management within a packet telephony network. Signaling allows call information to be carried across network boundaries. Session management provides the ability to control the attributes of an end-to-end call. SIP can be employed in Phone calls, multiparty conferences, video-on-demand and virtual presentations. SIP provides the capabilities to:
a) Determine the location of the target end point—SIP supports address resolution, name mapping, and call redirection
b) Determine the media capabilities of the target end point—Via Session Description Protocol (SDP), SIP determines the “lowest level” of common services between the end points. Conferences are established using only the media capabilities that can be supported by all end points.
c) Determine the availability of the target end point—If a call cannot be completed because the target end point is unavailable, SIP determines whether the called party is already on the phone or did not answer in the allotted number of rings. It then returns a message indicating why the target end point was unavailable.
d) Establish a session between the originating and target end point—If the call can be completed, SIP establishes a session between the end points. SIP also supports mid-call changes, such as the addition of another end point to the conference or the changing of a media characteristic or codec.
e) Handle the transfer and termination of calls—SIP supports the transfer of calls from one end point to another. During a call transfer, SIP simply establishes a session between the transferee and a new end point (specified by the transferring party) and terminates the session between the transferee and the transferring party. At the end of a call, SIP terminates the sessions between all parties.

Hereinafter, embodiments of the present invention will be described in detail with reference to the appended drawings.

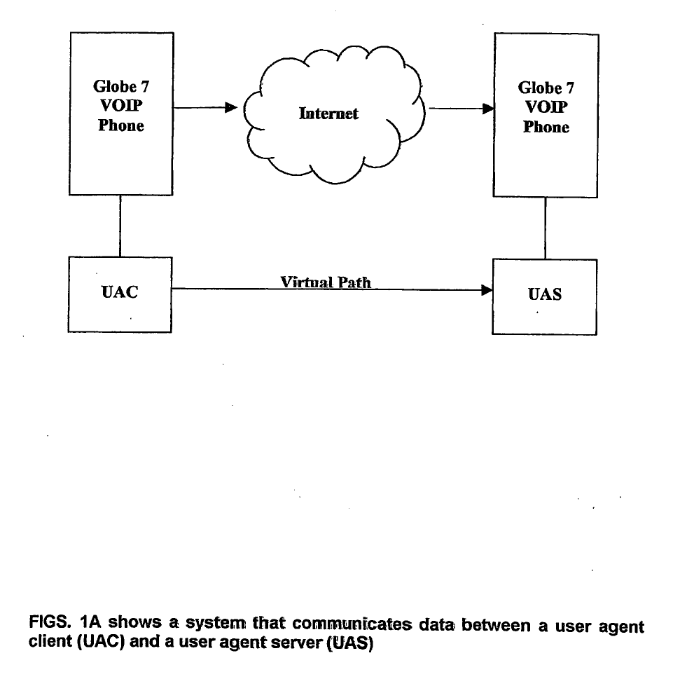

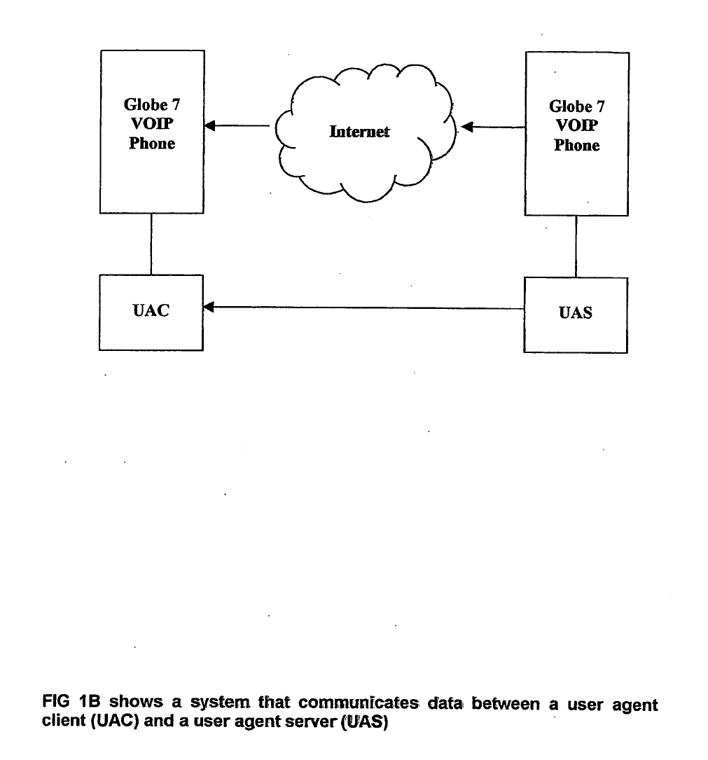

FIGS. 1A and 1B are views for explaining a system that communicates data between a user agent client (UAC) and a user agent server (UAS), according to the present invention.

Referring to FIG. 1A, a data communication system using Reliable Data Transfer (RDT) messages includes a User Agent Client (UAC) and a User Agent Server (UAS).

The client (UAC) is connected with the server (UAS) through the Internet or WAN via proxy servers.

Both terminals (client and server) communicate with each other using Session Initiation Protocol (SIP). SIP is a protocol developed for setting a session between VoIP terminals allowing speech communication, such as Internet telephones, PDAs, mobile phones, and the like. SIP, a text-based application layer protocol, supports P2P (Peer to Peer) communication between terminals so that two or more terminals can make, correct, and terminate a session. Accordingly, after initializing a session using SIP, the client (UAC) and the server (UAS) conduct P2P communication directly via a virtual path.

The RDT message is an expanded SIP according to the present invention, to which a function capable of increasing the reliability and stability of data transmission is added. The RDT message has all advantages provided by SIP, i.e., user mobility, minimal state maintenance, and independence for a lower layer protocol.

The client (UAC) requests desired data using an RDT message and checks whether the requested data is correctly received. The client (UAC) may be any of various terminals with a communication function supporting SIP and RDT messages, such as an Internet telephone, a PDA, a mobile phone, or a PC.

The server (UAS) combines the requested data with information capable of determining whether data is correctly transmitted, using an RDT message, and transmits the resultant data. The server (UAS) can perform at least one function among electronic commerce, contents distribution, Data-warehousing, and electronic documents management.

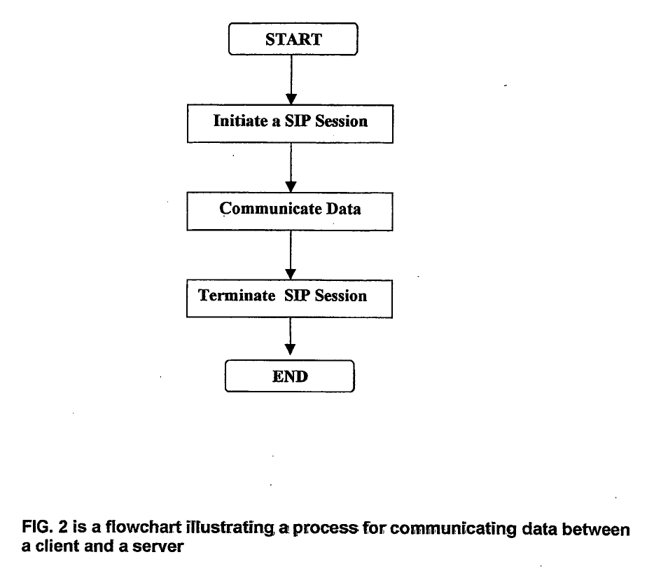

FIG. 1B shows a data communication system that has the same construction as shown in FIG. 1A, except that a client (UAC) is connected to a proxy server through a wire. FIG. 2 is a flowchart illustrating a process for communicating data between a client and a server, according to the present invention. Referring to FIG. 2, to receive or transmit data between a client (UAC) and a server (UAS), a session is initialized using SIP.

The present invention is now onwards termed as Globe Video Telephone Music Player is a SIP User Agent [RFC-3261] has multi-featured yet cost competitive phone designed for enterprises and residential use. It has unique features that are not available in other SIP phones. It has been fully tested for interoperability. It is based on the widely deployed SIP protocol design to meet the requirements of service providers and system integrators. Using Our Globe7 Video Telephone Music (VTM) Player you can call any mobile or land line in any corner of the world and similarly you can receive calls from the same. The player is also powered by SIP integrating MP3 player into it Globe7 Video Telephone (VTM) Player fulfills the entertainment needs by offering you the MP3 player to play your favorite songs umpteen times. Play any number of songs with unmatched voice quality on the desktop itself. There is a browser embedded in the present invention which plays some strips containing advertisements are displayed. There is a feature of Click To Call Available on these strips.

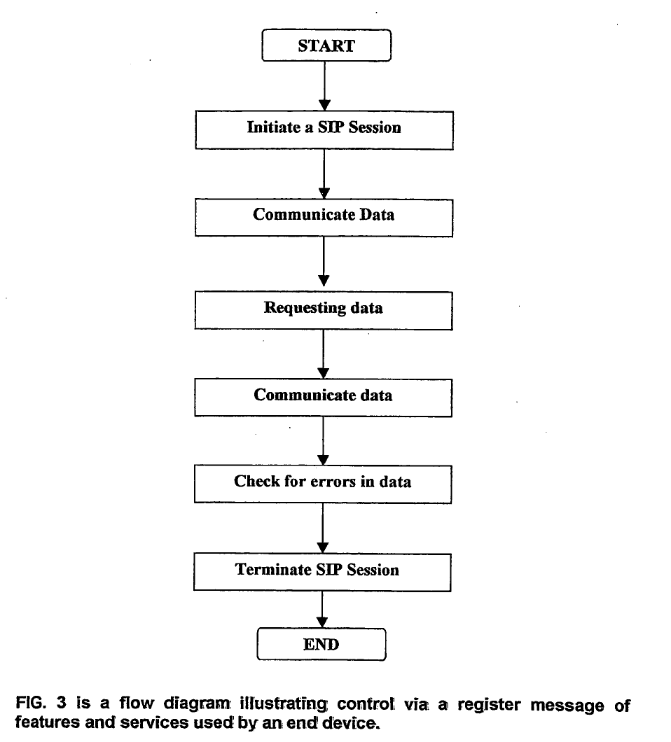

FIG. 3 is a flowchart illustrating a process for communicating random data. According to the present embodiment, comprises requesting a server UAS for random data using an RDT message, dividing the requested random data into blocks that are fundamental units of transmission, and communicating the random data, and determining whether there is an error in the received data. Referring to FIG. 3, if a session is initialized using SIP, an SIP session is formed between a client (UAC) and a server (UAS), which allows direct P2P communication between the client (UAC) and the server (UAS). The process for communicating the random data comprises a data request step, a data communication step, and a data check step.

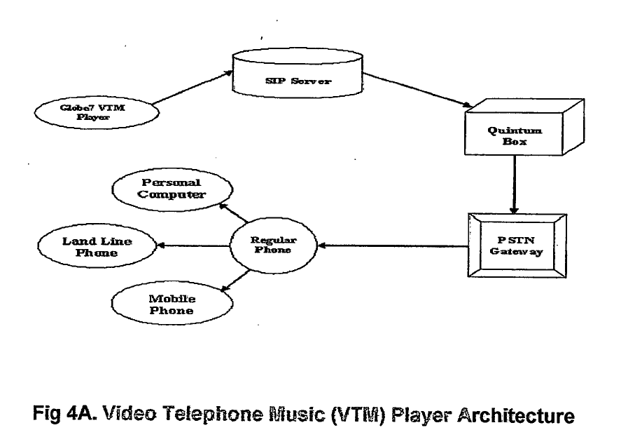

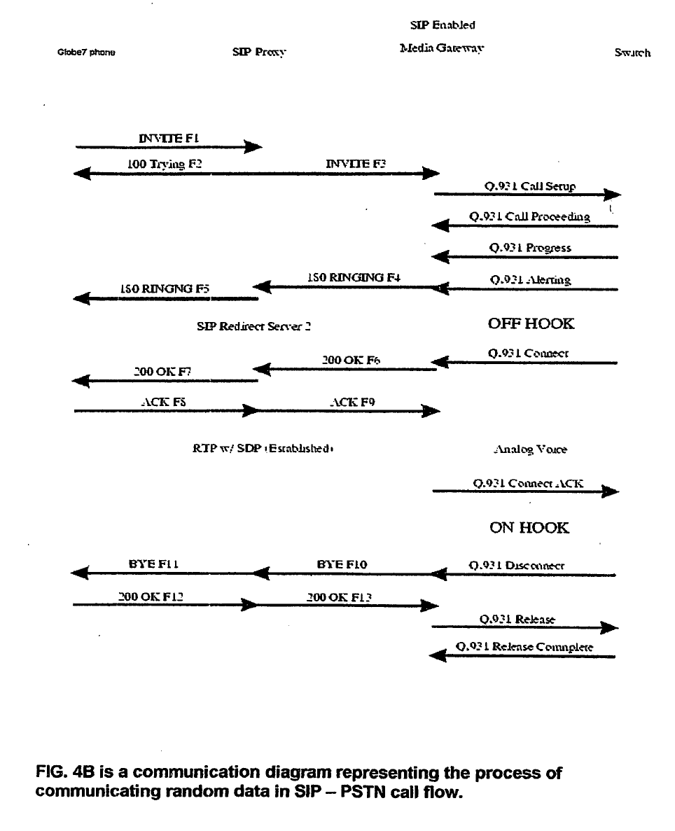

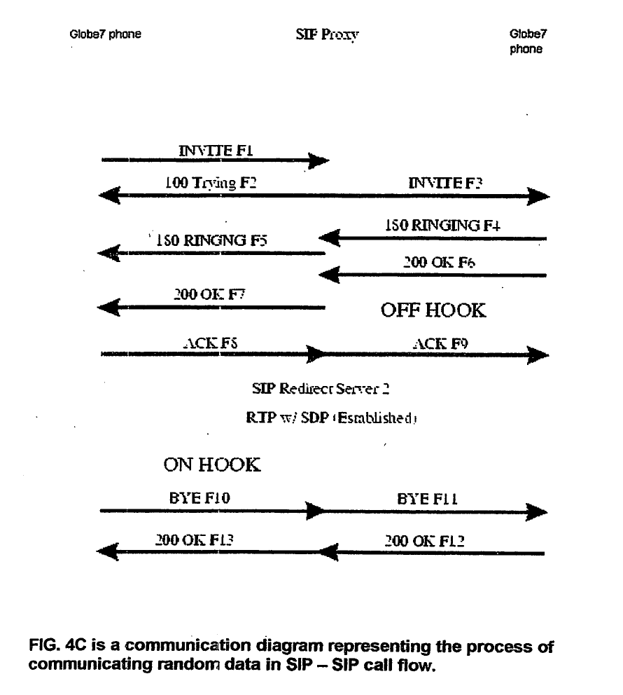

FIG. 4A shows the Player Architecture as per the present invention. FIG. 4B is a communication diagram representing the process of communicating random data in SIP-PSTN call flow. If a session is initialized using SIP, a SIP session is formed between a client (UAC) and a server (UAS), which allows direct P2P communication between the client (UAC) and the server (UAS). Similarly FIG. 4C is a communication diagram representing the process of communicating random data in SIP-SIP call flow.
Step 1: First, Globe7 Phone user agent A sends out an INVITE request to initiate a call. User Globe7 phone User agent B then replies with the Trying response code (100), indicating that the call request is being processed.
Step 2: Globe7 Phone user agent B then replies with the OK response code (200), indicating that that user agent has accepted the call.
Step 3: User agent A then replies to Globe7 Phone user agent B with an acknowledgement (ACK) request, indicating that user agent A received the final response code from Globe7 Phone user agent B.
Step 4: The real-time data is then encapsulated in RTP packets and sent between Globe7 Phone user agent A and Globe7 Phone user agent B. Either Globe7 Phone user agent A or Globe7 Phone user agent B can then send a BYE request, indicating that the user agent wants to terminate the session. Globe7 Phone user agent B then sends an OK response code (200) to Globe7 Phone user agent to indicate that the request has succeeded.
Here RTP Media Communication establishes on both sides.

FIG. 5 shows Globe7 Video Telephone Music (VTM) Player signaling Code Flow Diagrams The figure describes the basic flow in which the phone gets registered and after which the call generates. Here using the sip stack the call parameters are generated and the call signal is sent to the target callee or a call is received and is processed.

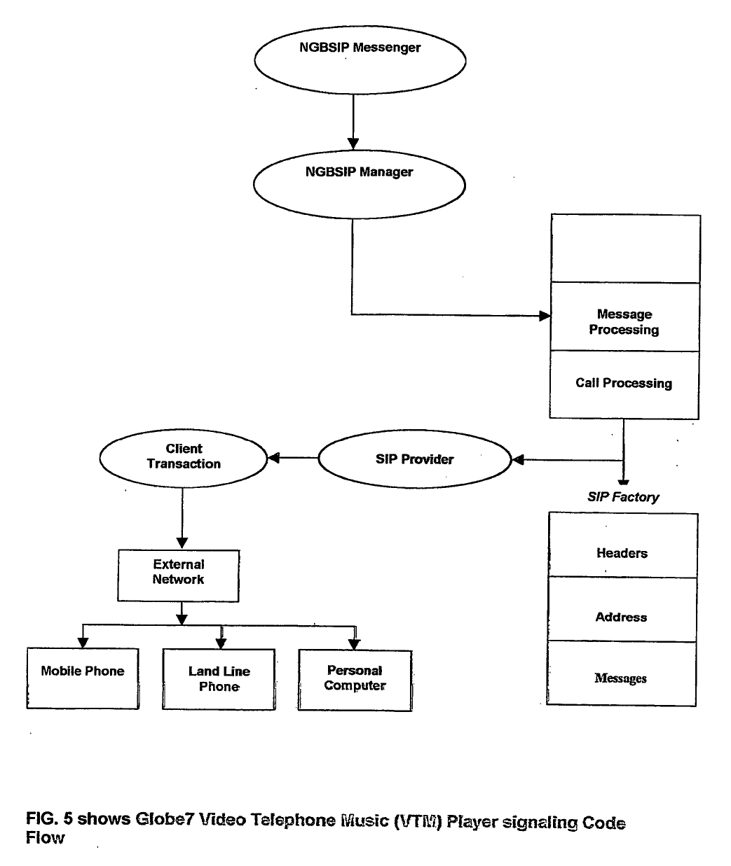

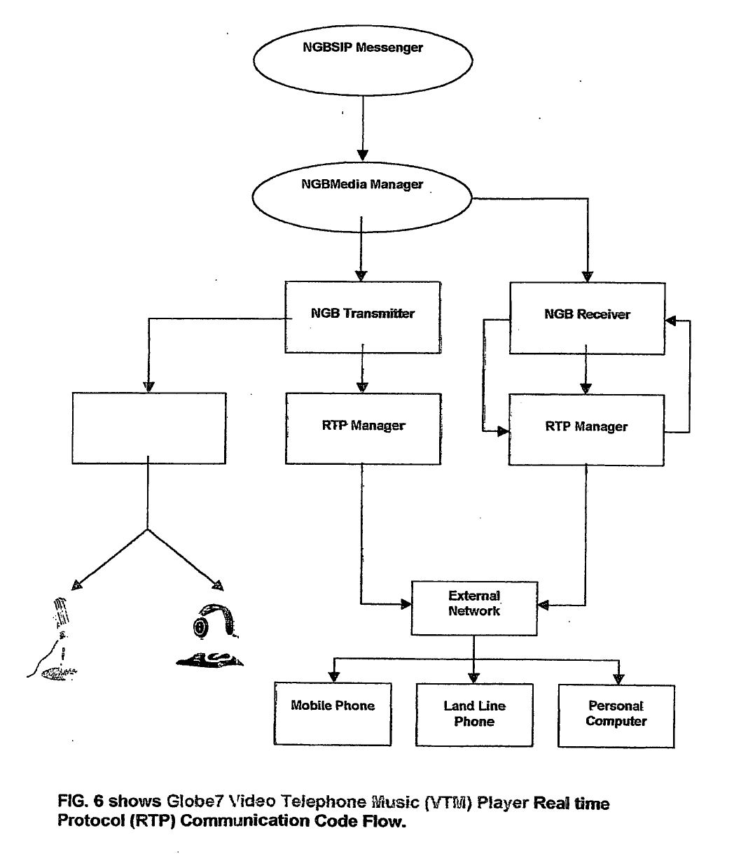

FIG. 6 shows Globe7 Video Telephone Music (VTM) Player Real time Protocol (RTP) Communication Code Flow. Herein once the call is established, the Real Time Protocol comes in to picture. The above diagram explains how the communication takes place, using Java Media Framework API the voice packets are generated and sent or received.

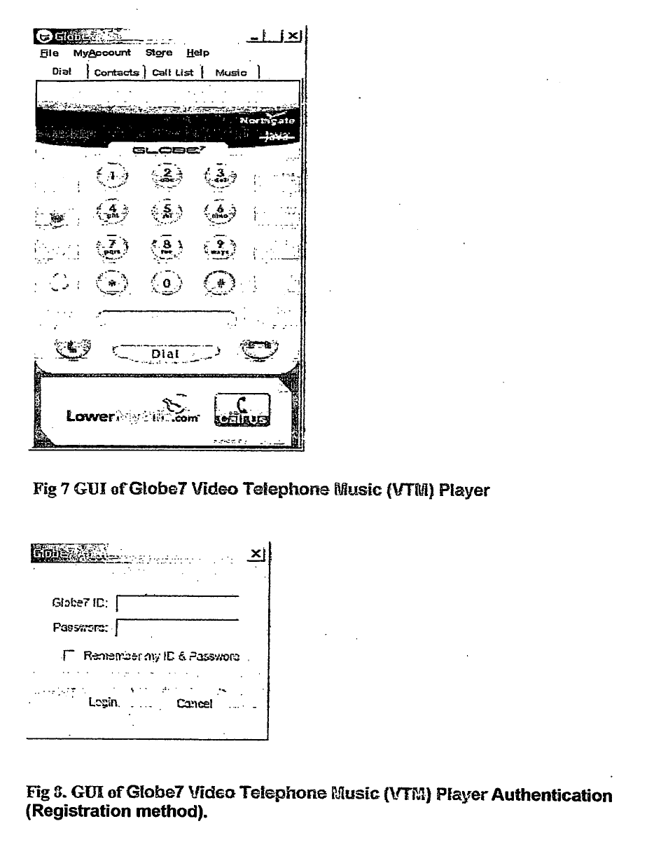

FIG. 7 shows the GUI (Graphical User Interface) of the Globe7 Video Telephone as per die present invention. The different innovative features/functions defined above are included in the interface. The Globe7 Video Telephone Music (VTM) Player uses, Jain SIP stack. The coding is done in Java and JMF Environment, which supports Telephone and Music Mp3 formats.

FIG. 8 shows the GUI (Graphical User Interface) of the authentication/Registration method of Globe7 Video Telephone. The GUI appears when the user selects and clicks the Globe7 exe icon, Authentication window will be opened along with the main screen. The software provides a unique User ID and a password for the user. The check box “Remember my ID & Password” saves the ID and password in the user's computer.

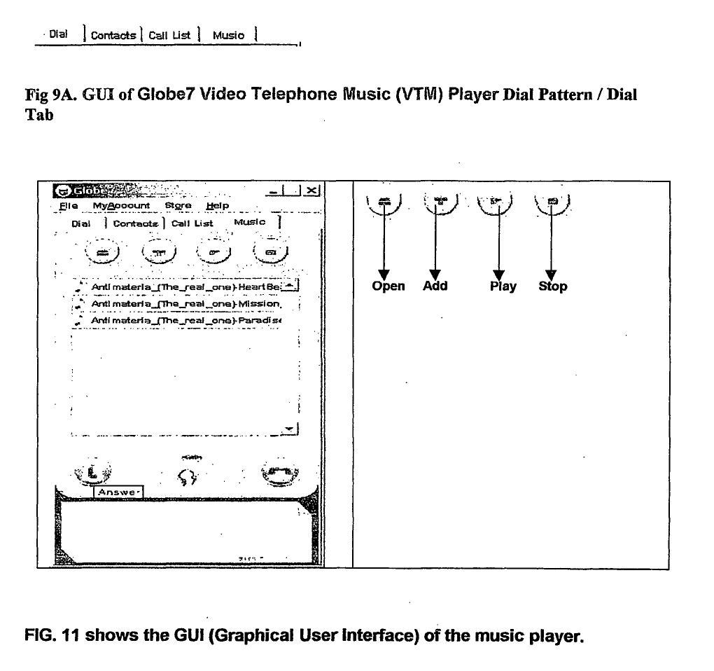

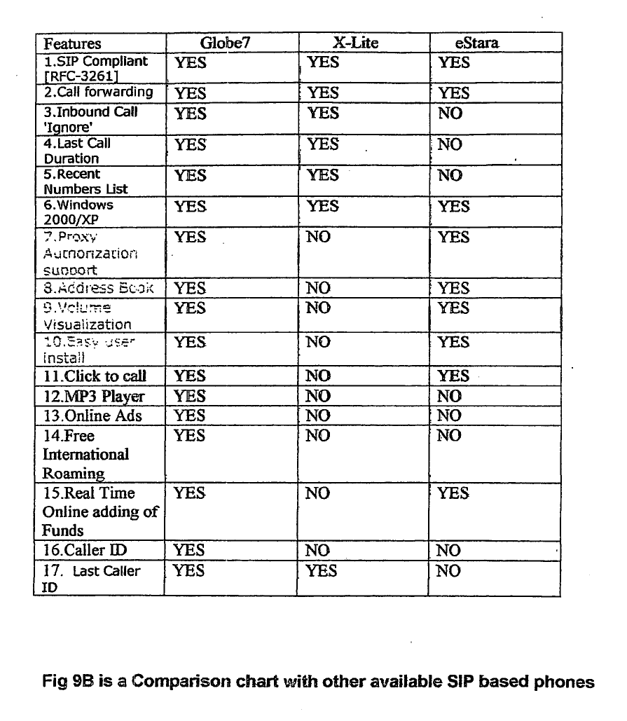

FIG. 9A shows the GUI (Graphical User Interface) of the dial pattern. As shown in the figure the “dial” tab/button appears as default. In the Dial tab, you can make, hang up or answer a call. Please note that until and unless one registers himself in the software and got his ID registered in the server, he can't make a call.

The call may be made in 3 different ways.
a). Entering the phone number in the text field and clicking the Dial button or pressing the Enter key.
b). Entering the phone number by clicking the number buttons.
c). While user clicks on these buttons, the values will eat in the text field.
   Thereby user can make a call by pressing the Enter key (or) by clicking the Dial button.

Dial is in this order: 00+Country code+Regional code+Telephone number.

The Status of the call is being displayed as below.
When user dials the number, he can see the status as the number is connecting [Ex: 0017816132085 is Connecting].
When the line or network is clear, user can hear the Ring Tone. And he will see the status as the number is ringing [Ex: 0017816132085 is Ringing].
When the called party answers the call, user can see the status as the number is connected [Ex: 0017816132085 is Connected].
If the user wants to hang up the call, he can click on the Hangup button. When he click the hang up button, the call will be disconnected. He can see the status as the number is disconnected. [Ex: 0017816132085 is Disconnected].
When the user receives a call from the outside party, he will get the status as the number is Alerting [Ex: 006565125001 is Alerting] at the display. He can answer the call by clicking the Answer button. He will see the status as the number is connected. [Ex: 006565125001 is Connected].

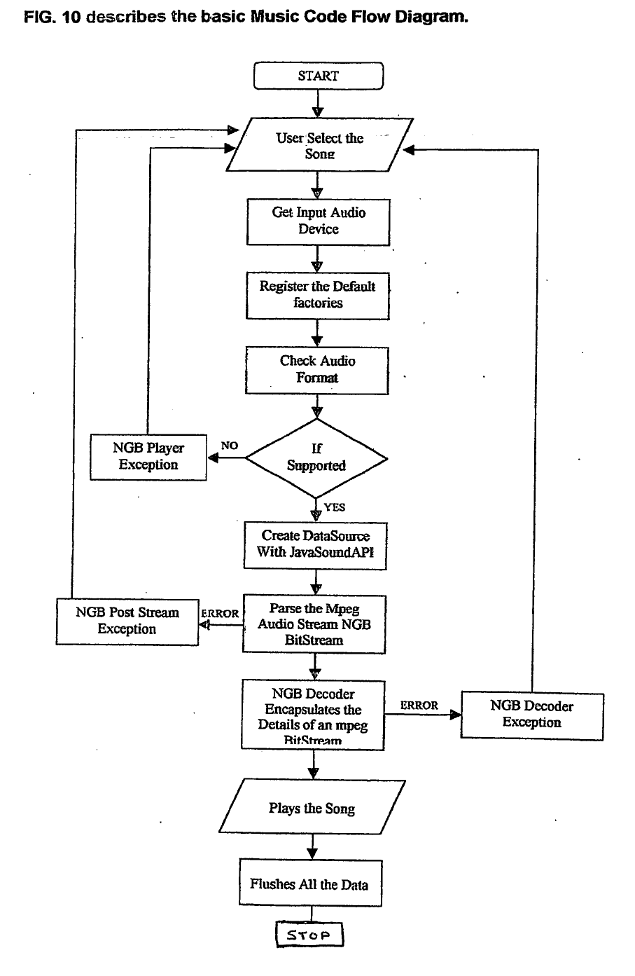

FIG. 10 describes the basic Music Code Flow Diagram. Apart from the soft phone features, an MP3 Player is also embedded in Globe7 Video Telephone Music (VTM) Player. This player supports only MP3 Format.

The Music Player as herein described is using Java Sound API. Currently It supports only MP3 formats. when a song is selected from play list it decodes the MP3 file and plays. One can play innumerable songs any number of times. The player plays any number of songs with unmatched voice quality on users desk top itself.

This MP3 plug-in application is being developed using Java sound API. There is a jukebox and user can play the songs stored on his system.

FIG. 11 shows the GUI (Graphical User Interface) of the music player. As shown in the figure the “Music” tab/button appears as default. Using the Music tab, one can Play an MP3 song/music and access the juke box and one can play the songs stored on the system when the phone is not in use. The interface shows four different operating modes i.e. 1. Open 2. Add 3. Play 4. Stop

Open->When user clicks on the Open button, file dialog appears, so that he can select the song from the directory. It doesn't appear in the list but it plays from the place where it is located.

Add->When user clicks the Add button, file dialog appears so that he can select the song from the directory. When he clicks Open, the song will be added to the list.

Play->The Play button simply starts playing the chosen Music or use the default setting for the play

Stop->The Stop button stops playing the chosen Music.

To Play a song, the user can Double click on the song from the list (or), Right click the song and then click Play. Similarly to stop a song, the user can Right click the song and click Stop (or), Click the Stop button. To Delete a song, the user can Right click the song and click Delete (or), Select the song and press Delete.

The above-described embodiments of the invention are intended to be examples of the present invention. Numerous modifications changes and improvements within the scope of the intention will occur to the reader. Those of skill in the art may effect alterations and modifications thereto, without departing from the scope of the invention, which is defined solely by the claims appended hereto.

1. A system for controlling multimedia features and supplementary services in SIP based phones, the system comprising:
at least one user agent client (UAC), operable to request desired data using a Reliable Data Transfer (RDT) message as an expanded Session Initiation Protocol (SIP) and check whether the data is correctly received; and
at least one user agent server (UAS), operable to combine the requested data with information indicating whether the data is correctly transmitted, using the RDT message as the expanded SIP, and transmit the resultant data; and
a SIP terminal which supports two way communication with another SIP entity in real-time and also supports both signaling and media; and
at least a Proxy server capable of contacting at least one client or the next-hop server and passes the call request further; and
at least a Redirect Server capable of accepting SIP requests; and
at least a Location Server capable of providing information about a caller's possible locations and redirect to the proxy servers
a Reliable Data Transfer (RDT) message processor capable to convert information on requested data into an RDT message and extract the requested data from a received RDT message;
a data controller, operable to send information on requested data to the RDT message processor and transfer a transformed RDT message to the SIP stack, and send an RDT message received from the SIP stack to the RDT message processor and transfer information on the extracted data to the data application unit.
a data application unit operable to process or store the extracted data;
a Session Initiation Protocol (SIP) stack operable to communicate an SIP message including an RDT message between the server;
wherein a processor adapted to control multimedia services and supplementary services which includes the controlling features and services like SIP complaint [RFC-3261]

2. The system as claimed in claim 1 wherein the said system comprises the multimedia services and supplementary services which includes:
Call forwarding, Call blocking or Ignoring calls, Call return, Call trace, Last Call Duration, Recent Number List, Caller ID, Compatibility with Windows 2000/XP operating systems, Proxy Authorization support, Address Book, Volume Visualization, Easy User Installation, Click to call. Music player, Business Processing, Realtime online adding of funds, Caller ID blocking, Priority ringing and Conference calling.

3. The system as claimed in claim 1 wherein the user agent client (UAC), is any one among an Internet phone, a computer, a telephone, a PDA, and a mobile phone.

4. The system as claimed in claim 1 wherein the proxy server is capable of containing UAC and UAS within the server.

5. The system as claimed in claim 1 wherein the redirect server maps the addresses into zero or more new addresses and return those addresses to the client and does not initiate SIP request or accept calls.

6. The system as claimed in claim 1 wherein the location server may be co-located with the SIP server.

7. The system as claimed in claim 1 wherein the SIP terminal server is similar to H.323 terminal which contains UAC.

8. An improved method for controlling multimedia features and supplementary services in SIP based phones, the method comprising the steps of:
generating a caller application which initiates and sends SIP requests through least one user agent client (UAC); and
receiving and responding to the SIP requests on the behalf of the clients through at least one user agent server (UAS); and
contacting one or more clients or the next hop server and passing the call requests further through at least one proxy server; and
accepting the SIP requests and mapping the addresses into zero or more new addresses and returns those addresses to the clients by at least one Redirect Server; wherein:
the multimedia services and supplementary services includes:
Call forwarding, Call blocking or Ignoring calls, Call return, Call trace, Last Call Duration, Recent Number List, Caller ID, Compatibility with Windows 2000/XP operating systems, Proxy Authorization support, Address Book, Volume Visualization, Easy User Installation, Click to call. Music player, Business Processing, Realtime online adding of funds, Caller ID blocking, Priority ringing and Conference calling.

9. A method as claimed in claim 1 further comprising the steps of:
identifying a profile from user account information stored on at least one server, the profile specifying which features and services may or may not be
implemented by an end device;
adding the profile to at least one message; and
sending the at least one message from the network core device to the end device.

10. A method as claimed in claim 1 further comprising the step of implementing on the end device (UAC) only the features and services allowed to be implemented by the profile of the at least one message.

11. The method as claimed in claim 1 further comprising the step of using a session initiation protocol phone for the end device (UAC) and a session initiation protocol server for the (UAS).
